(19) United States
(12) Patent Application Publication
(10) Pub. No.: US 2023/0073786 A1
(43) Pub. Date: Mar. 9, 2023

(54) PARTICLE SEPARATION

(71) Applicant: HEWLETT-PACKARD DEVELOPMENT COMPANY, L.P., Spring, TX (US)

(72) Inventors: Yang LEI, Palo Alto, CA (US); Viktor SHKOLNIKOV, Palo Alto, CA (US); Daixi XIN, Palo Alto, CA (US)

(21) Appl. No.: 17/467,098

(22) Filed: Sep. 3, 2021

(51) Int. Cl. B03C 5/02; B03C 5/00

(52) U.S. Cl. CPC B03C 5/026; B03C 5/005; B03C 2201/26

(57) ABSTRACT

For some examples, an apparatus to effect particle separation may include a dielectrophoretic particle separator that may separate particles within a focused particle stream. The dielectrophoretic particle separator may apply an electric field to the particles. An imaging system may capture images of the particles passing through a separation region of the dielectrophoretic particle separator. An image processing and control system may process the images to obtain information regarding the particles and may adjust an operating parameter of the dielectrophoretic separator based upon the information regarding the particles.

### BACKGROUND

Particle separation is used in a variety of applications. For example, separation devices can be used to extract rare particles out of a mixture of common particles (e.g., where a ratio of common to rare is <1:1000). For example, in the medical industry, particle separation devices may be used to separate cells or other particles in solution.

### BRIEF DESCRIPTION OF THE DRAWINGS

Examples of the disclosure will be rendered by reference to specific examples thereof which are illustrated in the appended drawings. The drawings illustrate only particular examples of the disclosure and therefore are not to be considered to be limiting of its scope. The principles herein are described and explained with additional specificity and detail through the use of the accompanying drawings in which:

FIG. 1 illustrates a process for particle separation according to examples of the present disclosure.

FIG. 2 illustrates an example DEP particle separator that may be used in a particle separation system in accordance with examples of the present disclosure.

FIG. 3 illustrates a particle separation system in accordance with some examples of the present disclosure.

FIG. 4 illustrates example instructions stored on an example non-transitory computer-readable storage medium to implement particle separation using image-based signal control of a DEP particle separator according to examples of the present disclosure.

### DETAILED DESCRIPTION

Examples of the present disclosure may provide a particle separation system that includes a dielectrophoresis (DEP) particle separator in conjunction with a particle imaging system that may be an optical imaging system such as an optical microscopy imaging system. A portion of the DEP particle separator may be transparent to allow for optical imaging of particles passing through the DEP particle separator. For examples, a separation region of the DEP particle separator may have at least one optically transparent wall to allow for optical imaging.

For some examples of the disclosure, the particle separation system may operate in either a continuous mode or an imaging mode. In a continuous mode, a signal generator of the DEP particle separator generates a signal with a specific amplitude and frequency which may be selected based upon characteristics of the particles to be separated. In an imaging mode, images of the particles may be used by an image processing system to obtain information regarding the particles. Such information may include location, recognition, and tracking information regarding the particle. A control system may use the information obtained from the image processing system to change the amplitude and/or frequency of the generated signal to adjust an electric field of the DEP particle separator.

DEP particle separators use dielectrophoresis to separate particles based on size and polarization properties. Such DEP particle separators use planar electrodes that generate non uniform force fields and therefore two particles with similar properties passing through the DEP separator experience widely varying force field strength. Therefore, some particles may not be deflected consistently to the desired region or channel of the DEP particle separator.

Examples of the present disclosure may use particle imaging to adjust the electric field of the DEP particle separator to deflect particles to a desired channel of a particle separation system. For some examples of the present disclosure, adjustments to an electric field of a DEP particle separator may be effected dynamically, as needed, while particles are passing through the DEP particle separator. Examples of the present disclosure may provide separation of particles in a high throughput continuous manner.

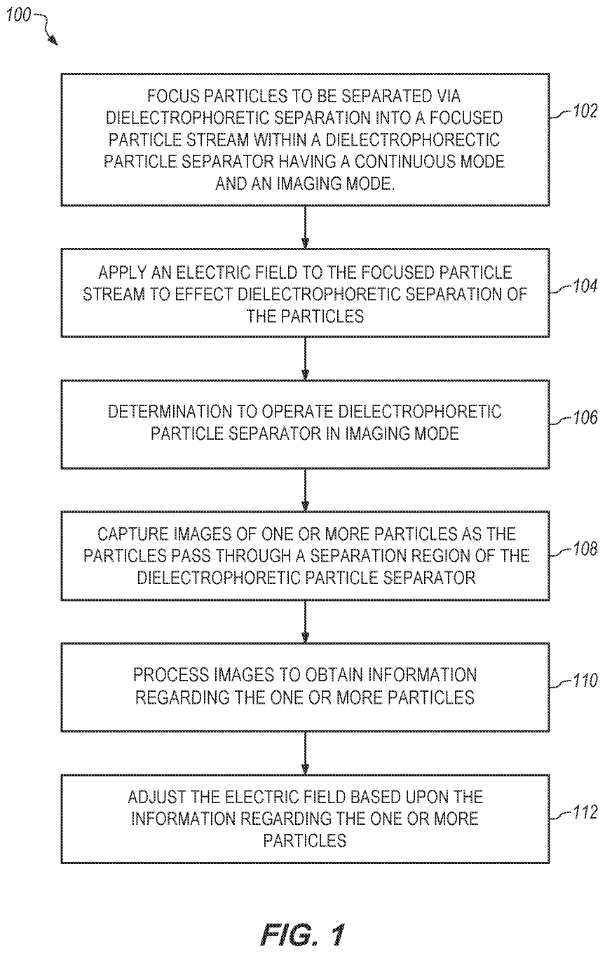

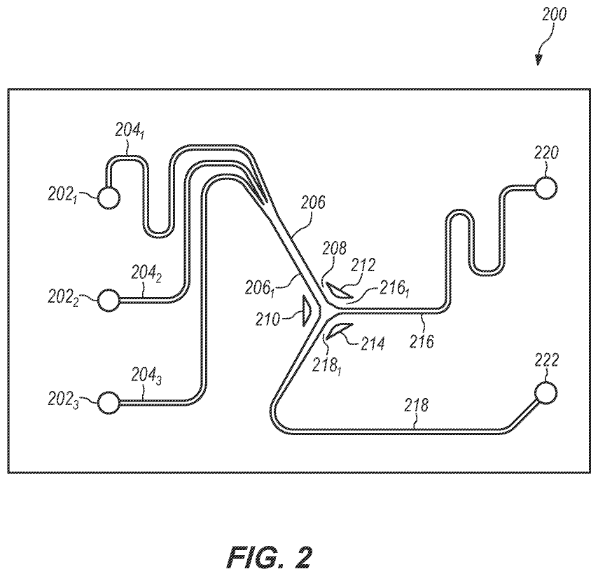

FIG. 1 illustrates a process by which particle separation is effected according to examples of the present disclosure. Process 100, shown in FIG. 1 begins with operation 102 in which particles to be separated via DEP separation are focused to create a focused particle stream within a DEP particle separator. For some examples, the focused particle stream may be created by a focusing region of a DEP particle separator (e.g., focusing channel 206, described below in reference to FIG. 2). For example, a solution with particles of interest may be placed into reservoir. A flow control system may pump the particles and a sheath fluid into a microfluidic chip and through the focusing area. The particles are focused into a plane or a stream tube, and thus enter a separation region (e.g., separation region 208, described below in reference to FIG. 2).

At operation 104 an electric field is applied to the focused particle stream to effect dielectrophoretic separation of particles within the focused particle stream. For some examples, the electric field may be produced by electrodes in the separation region of a DEP particle separator (e.g., electrodes 210, 212, and 214, of separation region 208, described below in reference to FIG. 2). These electrodes produce an approximately radially uniform dielectrophoretic force field when voltage is applied to them. For some examples, the DEP particle separator may operate, initially, in a continuous mode in which a signal generator generates a signal with a set frequency and amplitude and the particles are automatically separated based upon properties and characteristics of the particles.

At operation 106 a determination may be made to operate the DEP particle separator in imaging mode. The DEP particle separator may be operated in imaging mode upon the direction of a user or automatically, either periodically, or upon the occurrence of a specified event, or in response to other criteria. For example, if the applied electric field produced by the signal generated in continuous mode is not appropriate to direct the particles to the desire output channel, the particles may stagnate in the separation region or be directed to an undesired output channel. When such stagnation occurs, the DEP particle separator may begin operating in imaging mode automatically or at the direction of a user.

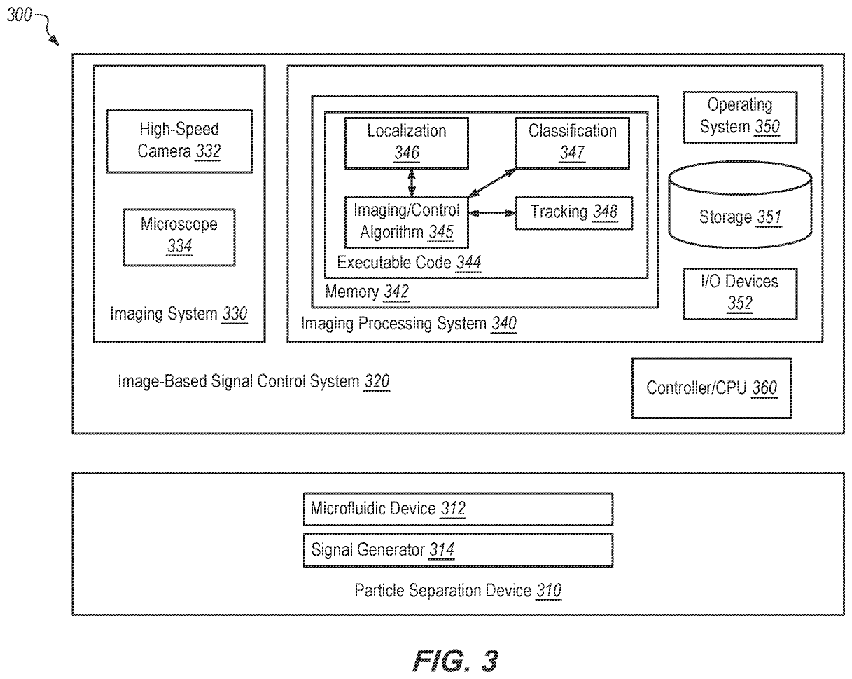

At operation 108 one or more images of particles are captured during dielectrophoretic separation. For some examples a high-speed optical imaging system (e.g., optical imaging system 330 described below in reference to FIG. 3) is used to capture images of particles as the particles pass through a separation region of a DEP particle separator. For some such examples, the separation region (e.g., separation region 208) may have at least one wall (ceiling or floor) optically transparent to allow imaging of the cells inside the region. For some examples, the imaging system may include a microscope and a high-speed camera. The imaging may be bright field, phase contrast, differential interference contrast, fluorescence or other. For some examples a high-speed camera may be capable of capturing 10,000 fps.

At operation 110 the images are processed to obtain information regarding the particles. For some examples, the images are processed and analyzed in real time by an imaging and control algorithm, and a decision is made to deflect the cell either into a channel for particles experiencing positive dielectrophoresis or a channel for particles experiencing negative dielectrophoresis. As noted above, such information may include recognition information to determine the type of particle, as well as location and tracking information to determine if the particle is on the correct path or streamline through the electric field (e.g., to a desired output channel).

At operation 112 the electric field is adjusted based upon the information regarding the particles. For some examples, a lookup table is employed to select an appropriate frequency that will cause the cell to undergo positive or negative dielectrophoresis as desired based on the type of particle as determined by the image processing. An appropriate voltage may be selected based upon the particle imaging. For some cases, for example, where the particles separated are cells, the particle size may be the primary differentiator of the voltage selected. For example, the voltage may scale as the linear dimension of the particle cubed. The selected frequency and voltage is then applied to the electrodes for a specified time to nudge the particles off their present streamlines and on to the streamlines going into the desired channel. The application time of the selected frequency and voltage may be calculated based on the observed location of the cell and its relative position in the flow field (distance to the desired streamlines). For other examples, the time may be obtained from a look up table based on the inlet flow rates.

For some examples, a default electric field (frequency and amplitude) is applied, which applies a default force on the cells. If the cells are observed to be not on the streamline going into the desired outlet channel (as observed by cell tracking), the control algorithm may change the electric field to one that will direct the cell into the desired outlet channel.

For some examples, during operation in imaging mode, the voltage and frequency of the generated signal may be adjusted periodically or in real time based upon the image processing and analysis in accordance with an imaging and control algorithm as discussed above.

FIG. 2 illustrates an example DEP particle separator that may be used in a particle separation system in accordance with examples of the present disclosure. DEP particle separator 200, shown in FIG. 2 may be a microfluidic device which may include a microfluidic chip and a signal generator. As illustrated, DEP particle separator 200 includes sample inlets 202₁-202₃ (hereinafter also referred to individually as an inlet 202 or collectively as inlets 202). The inlets 202 may receive a fluid containing a plurality of different particles that are to be separated by the DEP particle separator 200. Each inlet 202 may be coupled to a respective microfluidic inlet channel 204₁-204₃ (hereinafter also referred to individually as an inlet channel 204 or collectively as inlet channels 204).

For some examples, the inlet channels 204 may merge into a single focusing channel 206. The focusing channel 206 may be a region that is shaped to control a location of the particles in the fluid to create a focused particle stream. For example, the focusing channel 206 may be a tapered section in the inlet channels 204 to narrow the cross-section of the channel in which the fluid flows. The focusing channel 206 may be a dual axis focuser. For example, the focusing channel 206 may be tapered in both the vertical direction and the horizontal direction.

For some examples, the focusing channel 206 may focus the particles in the fluid as they move towards the DEP separation region 208. In one example, particle focusing may be effected using hydrodynamic flow focusing in which a sheath fluid that carries different particles may be injected to help particles to generally line up while passing through the focusing channel 206 to create a focused particle stream. The sheath fluid may provide for a relatively easier separation of the particles when the focused particle stream passes through the DEP separation region 208.

For some examples, the DEP separation region 208 has one inlet channel (e.g., focusing channel 206) fed by the focused particle stream and two or more outlet channels. The DEP separation region 208 may implement an electrical field on the particles in order to force the particles to be separated from each other and pass into different outlet channels, shown for example as outlet channel 216 and outlet channel 218.

The electric field effects the separation of particles because the particles exhibit dielectrophoretic activity in the presence of the electric field, and different particles may react differently in the presence of the electrical field and are, thereby, separated as they pass through the DEP separation region 208. For some examples, outlet channel 216, and outlet channel 218 may lead to output wells 220 and 222, respectively, where the separated particles or cells may be collected and analyzed.

For some examples, the DEP separation region 208 includes electrodes 210, 212, and 214, to implement the electric field. Electrodes 210, 212, and 214 may create electric fields across a portion of each of focusing channel 206, outlet channel 216, and outlet channel 218, the portions of each channel are referenced as channel portions 206₁, 216₁ and 218₁, respectively. The electrodes 210, 212, and 214 extend in a single plane such that they produce electric fields that extend in the same plane as that of focusing channel 206, outlet channel 216, and outlet channel 218. As shown in FIG. 2, electrode 210 may be a ground electrode that extends along alongside channel portions 206₁ and 216₁, the electrode 212 may extend alongside channel portions 206₁ and 218₁, and the electrode 214 may extend alongside channel portions 216₁ and 218₁.

The electrode 212 and the electrode 214 may be of opposite polarity. For example, electrode 212 may be a positive electrode and electrode 214 may be a negative electrode, or vice versa. Each of the electrodes 210, 212, and 214 may be a continuous electrode or may be formed by multiple separate elements connected to ground or a source of electrical current, such as an alternating frequency electric current source.

In one example, an AC signal generator (e.g., signal generator 314 of FIG. 3) may apply a current or voltage through the electrode 212 and electrode 214 to create an electrical field. The electric field generates an approximately radially uniform dielectrophoretic force on the particles as the particles pass through the DEP separation region 208. The frequency and voltage of the AC signal will cause different particle types to experience a different dielectrophoretic force. As a result, particles of interest will be moved to one channel (e.g., output channel 216) and other particles will be moved to another channel (e.g., output channel 218). The frequency and amount of voltage or current that is applied may depend on the type of particle or cells that are injected into the inlet channels 204.

For some examples, the DEP separation region 208 has at least one portion that is optically transparent. The optically transparent portion of the DEP separation region 208, which may be a top wall (ceiling), or bottom wall (floor) allows optical imaging of the particles as the particles pass through the DEP separation region 208 region. Particle imaging in accordance with examples of the present disclosure is discussed more fully below.

FIG. 3 illustrates a particle separation system in accordance with some examples of the present disclosure. System 300, shown in FIG. 3 includes a particle separation device 310, and an image-based signal control system 320 (control system 320).

For some examples, particle separation device 310 may be a DEP particle separator as discussed above in reference to FIG. 2. Particle separation device 310 may include a microfluidic device 312 and a signal generator 314 to effect DEP separation of particles within a fluid. Particle separation system 300 may be capable of operating in a continuous mode in which the amplitude and frequency of the generated signal may be static or an imaging mode in which the amplitude and frequency of the generated signal may be adjusted based upon information regarding the particle obtained from an image processing system as discussed above.

Control system 320 may include an imaging system 330. For some examples, particles passing through a focusing channel (e.g., focusing channel 206) of the microfluidic device 312 are merged into a focused particle stream. As discussed above in reference to FIG. 2, the focusing channel may be a region that is shaped to control a location of the particles in the fluid to create a focused particle stream. The focusing channel may be a tapered section in the inlet channels and may be tapered in both the vertical direction and the horizontal direction.

For some examples, as particles flow through the focusing channel of the microfluidic device 312, the particles are focused into a narrow plane or stream tube to order the particles into a queue (a focused particle stream). These ordered particles may then enter the separation region (e.g., separation region 208) of the microfluidic device 312 where they are affected by a dielectrophoretic force resulting from an electric field produced by signal generator 314 applied to the particles.

The particles may be directed by the dielectrophoretic force to one of several output channels of the microfluidic device 312 (e.g., output channels 216 and 218 described above in reference to FIG. 2). As discussed above, while operating in continuous mode, signal generator 314 may generate a signal with a set amplitude and frequency. If the applied electric field resulting from the generated signal is not appropriate to direct the particles to the desire output channel, the particles may stagnate in the separation region or be directed to an undesired output channel. Upon such occurrence or as directed by a user, the particle separation system 300 may be operated in an imaging mode. Initially, the particle separation system operating in an imaging mode may use the same amplitude and frequency as continuous mode operation or may be initialized to a predetermined amplitude and frequency until the system has obtained information regarding the particles on which to base an adjustment to the amplitude and frequency.

As discussed above, the imaging/control algorithm 345 may determine an appropriate amplitude and frequency for the signal generator 314 to cause the cell to undergo positive or negative dielectrophoresis as desired. The imaging/control algorithm 345 may select an amplitude and frequency for the signal generator 314 based upon information regarding the particles. For some examples, the selection is made by reference to a stored lookup table, which may be stored in storage system 351. Based upon the particle information obtained from the particle image processing, the imaging/control algorithm 345 may effect adjustments of other operating parameters of the particle separation system 300.

For some examples, as particles pass through the separation region, the particles are imaged by imaging system 330. As noted above, a portion of the separation region of the DEP particle separator may have at least one optically transparent wall to allow for optical imaging of particles passing through the DEP particle separator. For some examples, the microfluidic device 312 may be fabricated as a silicon or polymer substrate with a glass plate coupled to the top surface. For some examples of the present disclosure, a portion of the separation region of the DEP particle separator may have a wall or other portion that allows for other types of imaging (e.g., magnetic resonance, ultrasonography, thermography, etc.).

Imaging system 330, which, for some examples may be an optical microscopy imaging system, may include a high-speed camera 332 and a microscope 334. High-speed camera 332 and microscope 334 may be optically coupled one to another and to the particle separation device 310.

For some examples, the particles are imaged by imaging system 330 as they pass through the separation region. For some examples, the particle imaging may be controlled by the imaging/control algorithm 345 and may be periodic. For example, imaging may occur at specified intervals or may occur periodically based upon information regarding the particles. For some examples the imaging may be continuous throughout the particle separation process.

According to examples of the disclosure, the frequency and voltage applied by the signal generator 314 may be dynamically adjusted based on images captured by imaging system 330. The particle images may be loaded into memory, for example, memory 342 of image processing system 340, which may include, for example, random access memory. The particle images are then processed in real time by the imaging/control algorithm 345. The particle imaging provides information about the particles that is used by the imaging/control algorithm 345 to make decisions about the particle including how the particle should be deflected, for example, to which output channel the particle should be deflected.

As discussed above, the imaging/control algorithm 345 may determine an appropriate amplitude and frequency for the signal generator 314 to cause the cell to undergo positive or negative dielectrophoresis as desired. The imaging/control algorithm 345 may select an amplitude and frequency for the signal generator 314 based upon information regarding the particles. For some examples, the selection is made by reference to a stored lookup table, which may be stored in storage system 351. Based upon the particle information obtained from the particle image processing, the imaging/control algorithm 345 may effect adjustments of other operating parameters of the particle separation system 300.

For some examples, upon determination of a desired amplitude and frequency, the Controller/CPU 360 transmits a control signal to signal generator 314 to implement the desired signal for particle separation. For some examples, the Controller/CPU 360 may be coupled to input/output devices 352 which may include a user interface such as a display panel and an input device, for example, a touch screen or keypad, among others. The input/output devices 352 may enable a user of the particle separation system 300 to interact with and implement the functionality of the particle separation system 300 as described herein.

Image Processing

As discussed above, information regarding many aspects or characteristics of the particle may be obtained through imaging/image processing. Some information which may be useful for particle separation includes size, shape, color, and reflectivity, among others. For examples in which the particles to be separated are human cells, localization information, recognition information, and tracking information may be helpful to effect cell separation. As shown in FIG. 3, the imaging/control algorithm 345 may include a localization module 346, a classification module 347, and a tracking module 348. Localization module 346 obtains information regarding the location of the cell as is passes through the separation region. Classification module 347 obtains cell recognition information. Tracking module 348 obtains information regarding the cell path.

Cell localization may be helpful as the location of the cell as it passes through the separation region may help determine if cells are moving through the separation region and directed to a desired output channel for proper cell separation. The cell location information may indicate that adjustments may be required for proper cell separation. For some examples, a cell location near the upper portion of the output channels as the cell passes through the separation region indicates proper cell separation. Cell location near the lower portion of the output channels may indicate an adjustment to the operating parameters of the DEP particle separator may be required for proper cell separation.

Cell recognition may be helpful to determine the particular type of cell. Cell recognition may help determine which type of cells are being directed to which output channels. Identified cells directed to an undesired output channel may indicate an adjustment to the operating parameters of the DEP particle separator may be required for proper cell separation.

As discussed above, cell tracking may be helpful to determine if the cell is on the correct path or streamline through the electric field (e.g., to a desired output channel). Cells are observed to be not on the streamline going into the desired outlet channel may indicate an adjustment to the operating parameters of the DEP particle separator may be required for proper cell separation.

For some examples of the disclosure, a deep learning architecture (e.g., convolutional neural networks) may be used to determine location information, recognition information, and tracking information. For example, a real-time image analysis algorithm may recognize the types of cells using their morphology, localize cells in each image and track the cells while they are in the field of view of the imaging system. The algorithm may use this information to adjust operating parameters (e.g., electric field) of a DEP particle separator.

For some examples of the disclosure, determining cell localization information, cell recognition information, and cell tracking information may be effected separately by the imaging/control algorithm 345 using the localization module 346, the classification module 347, and the tracking module 348, respectively.

For other examples, determining cell localization information and cell recognition information may be effected concurrently after which determining cell tracking information may be effected. For example, individual images may be analyzed to determine cell localization and cell recognition using semantic segmentation methods to classify all the image pixels and generate a label image assigning different labels (e.g., differing intensity or color) to different types of cells. For some examples of the disclosure, semantic segmentation methods may be effected using a convolutional neural network (e.g., U-Net).

Or, for example, individual images may be analyzed to determine cell localization and cell recognition using detection methods that identify the location of cells and determine bounding boxes surrounding individual cells. Detection methods also determine the particular cell type for each detected cell. For some examples of the disclosure, detection methods may be effected using a neural network-based, real time object detection method (e.g., YOLO, Faster R-CNN, Mask R-CNN).

Using the determined cell localization information and cell recognition information, cells are matched for successive individual images to effect the determination of cell tracking information. For some examples of the disclosure, Kalman filtering is used to determine cell tracking information. For example, Kalman filtering may be used to predict cell location/velocity in a subsequent image based on the location/velocity of the cell from previous images.

For some examples of the disclosure, determining cell localization information, cell recognition information, and cell tracking information may be effected together directly on an image sequence. The concurrent determination of cell localization information, cell recognition information, and cell tracking information may be effected using a convolutional neural network that addresses multi-object tracking and segmentation (e.g., Track R-CNN).

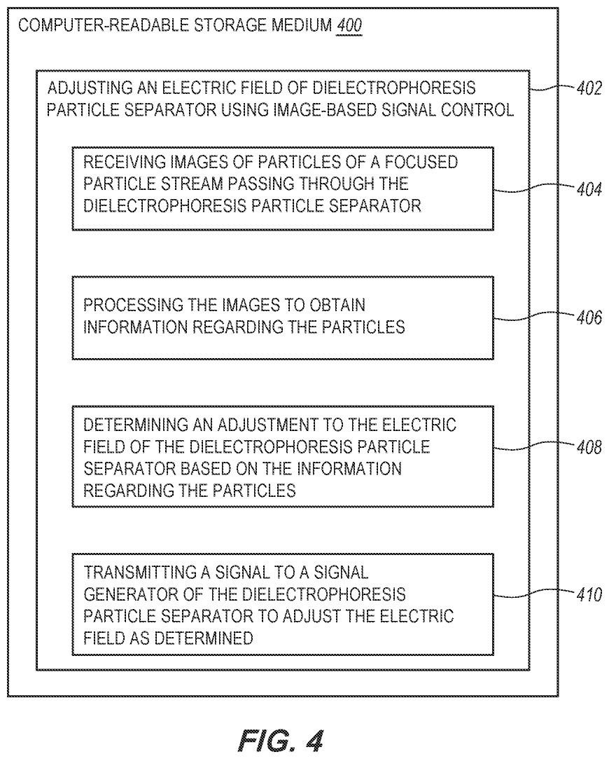

FIG. 4 illustrates example instructions stored on an example non-transitory computer-readable storage medium to implement particle separation using image-based signal control of a DEP particle separator according to examples of the present disclosure.

As shown in FIG. 4, the non-transitory computer-readable storage medium 400 includes instruction 402 that may cause a processor to adjust an electric field of a DEP particle separator using image-based signal control. Instruction 402 may include instruction 404, instruction 406, instruction 408 and instruction 410.

Instruction 404 may cause a processor to perform the operation of receiving images of particles of a focused particle stream passing through a DEP particle separator. As discussed above, the particles may be focused into a focus particle stream by a focusing region of a DEP particle separator. The focusing region may comprise a tapered section of an inlet channel that may narrow the cross-section of the inlet channel.

Instruction 406 may cause a processor to perform the operation of processing particle images to obtain information regarding the particles. As discussed above, the information regarding the particles may include particle localization information, particle recognition information, and particle tracking information, among others.

Instruction 408 may cause a processor to perform the operation of determining an adjustment to an electric field of a DEP particle separator based on information regarding the particles.

Instruction 410 may cause a processor to perform the operation of transmitting a signal to a signal generator of the DEP particle separator to effect adjustment of the electric field as determined.

The non-transitory computer-readable storage medium 400 may be any electronic, magnetic, optical, or other physical storage device that stores executable instructions. For example, the non-transitory computer-readable storage medium 400 may be a random access memory (RAM), an electrically-erasable programmable read-only memory (EEPROM), a storage drive, an optical disc, or the like. The non-transitory computer-readable storage medium 400 can be encoded to store executable instructions that cause a processor to perform operations according to examples of the disclosure.

Image-based signal control system 320, described above in reference to FIG. 3 may be implemented on a computing system that may be, for example, a personal computer, a desktop computer, a mobile computer, a laptop computer, a notebook computer, a terminal, a workstation, a server computer, a network device, or any other suitable computing device.

Referring again to system 300, shown in FIG. 3, control system 320 includes a controller/CPU 360 that may be, for example, a CPU, a chip or any suitable computing or computational device. As shown, control system 320 includes an operating system 350, a memory 342, executable code 344, a storage system 351 and input/output devices 352.

Controller/CPU 360 may be configured to carry out methods described herein and/or to execute various modules. Examples of the present disclosure may include more than one control system 320, and one or more control systems 320 may act as the components of a particle separator according to examples of the present disclosure.

Operating system 350 may be, or may include, any code designed and/or configured to perform tasks involving controlling or otherwise managing operation of control system 320. This may include scheduling execution of software programs or enabling software programs or other modules or units to communicate. As an example, operating system 350 may be a commercial operating system. For some examples of the disclosure, the control system 320 may include a computing device that does not use an operating system (e.g., a microcontroller, ASIC, FPGA, or SOC).

Memory 342 may be implemented in various forms including random access memory (RAM), read-only memory (ROM), volatile or non-volatile memory, a cache memory, or other suitable memory units or storage units. Memory 342 may be a computer-readable non-transitory storage medium.

Executable code 344 may be any executable code, e.g., an application, a program, or a process. Executable code 344 may be executed by controller/CPU 360 possibly under control of operating system 350. Examples of the present disclosure may include a plurality of executable code that may be loaded into memory 342 and cause controller/CPU 360 to carry out methods described herein.

Storage system 351 may be or may include, for example, a hard disk drive, flash memory, a micro controller-embedded memory, or removable storage. Content may be stored in storage system 351 and may be loaded from storage system 351 into memory 342 where it may be processed by controller/CPU 360. Although shown as a separate component, storage system 351 may be embedded or included in memory 342.

Input/output devices 352 may include any suitable input devices such as a keyboard/keypad, mouse and any suitable output devices such as displays or monitors. A universal serial bus (USB) device or external hard drive may be included in input/output devices 352. Any applicable input/output devices may be connected to control system 320 by, for example, a wired or wireless network interface.

As discussed above, examples of the present disclosure may include a computer-readable medium, which when executed by a processor may cause the processor to perform operations disclosed herein. According to examples of the present disclosure, executable code 344 includes executable code implementing image-based signal control of a DEP particle separator.

The various components of control system 320 as shown in FIG. 3 are illustrative and are not intended to limit the scope of the present disclosure. A control system according to examples of the present disclosure may include multiple interacting computing systems or devices, that may be connected to other devices including through one or more networks such as the Internet, via the Web, or via private networks. More generally, a control system may comprise any combination of hardware that may interact with and perform the described types of functionalities, optionally when programmed or otherwise configured with particular software instructions and/or data structures including without limitation desktop or other computers, database servers, network storage devices and other network devices. In addition, the functionality provided by the control system 320 as shown may in some examples be distributed in various modules. Similarly, in some examples, some of the functionality of the control system may not be provided and/or other additional functionality may be provided.

Furthermore, in some examples, some or all of the systems and/or modules may be implemented or provided in other manners such as by those consisting of one or more means that are implemented at least partially in firmware and/or hardware rather than as a means implemented in whole or in part by software instructions that configure a particular processor. The systems, modules, and data structures may also in some examples be transmitted via generated data signals on a variety of computer-readable transmission mediums, including wireless-based mediums and may take a variety of forms. Accordingly, examples of the present disclosure may be practiced with other computer system configurations.

Methods according to the above-described examples may be implemented using computer-executable instructions that are stored or otherwise available from computer readable media. Such instructions may include, for example, instructions and data which cause or otherwise configure a special purpose computer, or special purpose processing device to perform a certain function or group of functions. In some examples, some or all of the systems and/or modules may be implemented partially in firmware and/or hardware such as application-specific integrated circuits (ASICs), standard integrated circuits, controllers (e.g., microcontrollers), field-programmable gate arrays (FPGAs), complex programmable logic devices (CPLDs), etc. Some or all of the modules, systems and data structures may also be stored (e.g., as software instructions or structured data) on a non-transitory computer-readable storage medium, such as a hard disk or flash drive or other non-volatile storage device.

Although a variety of examples and other information was used to explain aspects within the scope of the appended claims, no limitation of the claims should be implied based on particular features or arrangements in such examples.

While the above description is a complete description of specific examples of the disclosure, additional examples are also possible. Thus, the above description should not be taken as limiting the scope of the disclosure which is defined by the appended claims along with their full scope of equivalents.

1. An apparatus comprising;
a dielectrophoretic particle separator to separate particles within a focused particle stream, the dielectrophoretic particle separator applying an electric field to the particles, the dielectrophoretic particle separator capable of operating in a continuous mode having set operating parameters or an imaging mode having operating parameters based upon images of the particles;
an imaging system to capture images of the particles passing through a separation region of the dielectrophoretic particle separator; and
an image processing and control system to process the images to obtain information regarding the particles and to adjust an operating parameter of the dielectrophoretic particle separator based upon the information regarding the particles.

2. The apparatus of claim 1, wherein the imaging system is an optical microscopy imaging system.

3. The apparatus of claim 2, wherein a portion of the separation region of the dielectrophoretic particle separator is optically transparent.

4. The apparatus of claim 1, wherein the operating parameter is the frequency and voltage of the electric field of the dielectrophoretic particle separator.

5. The apparatus of claim 1, wherein the focused particle stream is created as the particles pass through a tapered section of an inlet channel of the dielectrophoretic particle separator.

6. The apparatus of claim 1, wherein the particles are cells and the information regarding the particles includes cell localization information, cell recognition information, and cell tracking information.

7. The apparatus of claim 6, wherein the images are processed using a convolutional neural network to obtain the cell localization information, cell recognition information, and cell tracking information.

8. The apparatus of claim 1, wherein the imaging system includes a high-speed camera and the image processing and control system processes the images in real time.

9. A non-transitory, computer-readable storage medium having stored thereon instructions which when executed by a processor, cause the processor to perform operations comprising:
determining to operate a dielectrophoresis particle separator in an imaging mode;
receiving images of particles of a focused particle stream passing through the dielectrophoresis particle separator;
processing the images to obtain information regarding the particles;
determining an adjustment to an electric field of the dielectrophoresis particle separator based on the Information regarding the particles; and
transmitting a signal to a signal generator of the dielectrophoresis particle separator to adjust the electric field as determined.

10. The non-transitory, computer-readable storage medium of claim 9, wherein the images are received from an optical microscopy imaging system having a microscope optically coupled to a high-speed camera.

11. The non-transitory, computer-readable storage medium of claim 9, wherein processing the images includes using a convolutional neural network to determine particle location information, particle recognition information, and particle tracking information.

12. The non-transitory, computer-readable storage medium of claim 10, wherein the images are received continuously and processed in real time to effect periodic adjustment to the electric field.

13. A method comprising:
focusing particles to be separated via dielectrophoretic separation into a focused particle stream within a dielectrophoretic particle separator;
applying an electric field to the focused particle stream to effect dielectrophoretic separation of the particles;
determining to operate the dielectrophoretic particle separator in imaging mode;
capturing images of one or more of the particles as the particles pass through a separation region of the dielectrophoretic particle separator;
processing the images to obtain Information regarding the one or more particles; and
adjusting the electric field based upon the information regarding the one or more particles.

14. The method of claim 13, wherein an inlet channel of the dielectrophoretic particle separator includes a tapered section and the particles are focused into a focused particle stream as the particles pass through the tapered section of the inlet channel of the dielectrophoretic particle separator.

15. The method of claim 13, wherein images of one or more of the particles are captured using an optical microscopy imaging system.
